(19) United States
(12) Patent Application Publication
(10) Pub. No.: US 2007/0069601 A1
(43) Pub. Date: Mar. 29, 2007

(54) Rotor for an electrical motor

(75) Inventor: Niels Christian Weihrauch, Flensburg (DE)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 10/555,820

(22) PCT Filed: May 5, 2004
(86) PCT No.: PCT/DK04/00306

§ 371 Date: Nov. 4, 2005

(30) Foreign Application Priority Data
May 6, 2003 (DK) PA 2003 00674

(51) Int. Cl. H02K 17/00; H02K 19/14

(52) U.S. Cl. 310/166; 310/211

(57) ABSTRACT

The present invention provides to a rotor having a short circuit ring of an electrically conductive material. The short circuit ring has a curved outer surface whereby the eddy-current braking effect on the rotor caused by the stray field from the stator is reduced. The curved surface leads to an improved efficiency of an associated electrical motor. The invention further provides a motor with such a rotor and to the use of a rotor in an electrical motor.

### CROSS REFERENCE TO RELATED APPLICATIONS

This application is entitled to the benefit of and incorporates by reference essential subject matter disclosed in International Patent Application No. PCT/DK2004/000306 filed on May 5, 2004 and Danish Patent Application No. PA 2003 00674 filed May 6, 2003.

### FIELD OF THE INVENTION

The present invention relates to a rotor for an electrical induction motor of the kind provided with a rotor having windings connected to a short circuit ring. In particular, the invention relates to a rotor for an electrical motor of the kind provided with a stator and a winding generating a stray field that induces a voltage into a short circuit ring of the rotor, the short circuit ring forming an end part of the rotor, said end part having the shape of an annular body with an outer peripheral surface and an inner peripheral surface coaxially extending around a centre axis. The invention further relates to an electrical motor comprising the rotor, and to a line-start motor with a permanent magnet and a squirrel cage rotor.

### BACKGROUND OF THE INVENTION

Electrical induction motors are normally made with a laminated rotor comprising a plurality of substantially axially and optionally helically extending windings. Via short circuit rings, the windings are electrically interconnected at both axially disposed end faces of the rotor thereby affording the structure of a so-called squirrel-cage rotor. The short circuit rings are made with consideration on electrical conductivity. In general, induction motors are designed with short circuit rings providing the best possible conductivity within the available space and by use of a cost efficient material, e.g. aluminium. Often, the short circuit rings are made in an injection moulding process wherein a solid or laminated rotor core is arranged in the cavity of a mould of an injection-moulding machine. Subsequently, the windings and a short circuit ring at each end face of the rotor are made in one single injection. The mould is typically split into two form-parts, the split being approximately perpendicular to the axial direction of the rotor. In order to allow the rotor with the moulded short circuit rings to be removed from the mould, the existing short circuit rings are normally made with an outer surface being tapered in an axial direction. Normally, the tapering is in the size of 6-8 degrees from the axial direction of the rotor. Since the conductivity has generally been in focus during the design of rotors, it has always been a technical prejudice to minimize the tapering of the short circuit rings as much as possibly, of course under due consideration to the limitations set out by the moulding process, i.e. with as little tapering which at all supports the removal of the moulded piece from the mould.

It has, however, been found that the stray field from the winding overhang of the stator acts on the short circuit ring thereby causing an unwanted eddy-current braking effect, which reduces the efficiency of the electrical motor.

### BRIEF SUMMARY OF THE INVENTION

It is one object of the present invention to improve the efficiency of an electrical motor. Accordingly, the present invention, in a first aspect, provides a rotor for an electrical motor of the kind mentioned in the introduction and characterized in that a first of either the outer peripheral surface or the inner peripheral surface adapted to be closest to the stator of an associated electrical motor comprises a curved portion which slopes in a direction towards the other second surface.

Normally, the induction of the voltage in the short circuit ring causes a watt loss producing electrical circulation current in the short circuit ring, and due to the curved portion, the eddy-current braking effect can be reduced. As a result, the efficiency of the motor is improved. Although the electrical conductivity of the curved short circuit ring is reduced by the inventive measure compared to a conventional short circuit ring, thus reducing the electrical efficiency, the gain in reducing the circulation currents caused by the stray field results in an overall increase of the efficiency. Thus, when designing the curvature of the curved portion, attention must be given to minimise the reduction in electrical conductivity of the short circuit ring. Further, besides the electrical resistance of the ring, the shape of the curved portion is a function of the desired flow during moulding of the short circuit ring. If the curved portion has an incorrect curving the aluminium will not flow into the corners, thus leaving gaps.

In one embodiment, a tangent to the curved portion forms an angle to the centre axis, which angle is numerically larger than an angle of the second surface to the centre axis, and the angle could have a numerical value which is increasing with the distance to a centre part of the rotor. The angle of the tangent to the centre axis could be in the order of 2-5 times the numerical size of the angle of the second surface to the centre axis, or in general between 10 and 45 degrees to the centre axis.

Due to the angles of the tangent and of the surface, the rotor can be installed in an electrical motor so that the distance between the short circuit ring and the stator is increased towards the end part of the rotor.

It has thereby been achieved that the electrical conductive mass of the short circuit ring is concentrated mostly in the vicinity of the conductors of the rotor and less in the vicinity of the stray field from the stator. Accordingly, the eddy-current braking effect on the rotor is reduced and therefore, the rotor may lead to an improved efficiency of an associated motor.

A particularly good mass distribution of the conductive material of the short circuit ring is achieved with an angle of the first surface to the centre axis being in the order of two to five times the numerical size of the angle of the second surface to the centre axis and, preferably, the distance between the outer peripheral surface and the inner peripheral surface, i.e. the radial wall thickness of the annular body, is reduced towards the end part of the rotor.

It has been found that a stator ring with an angle of the first surface being in the range 10-45 degrees to the centre axis gives a good balancing between on the one hand having sufficient electrically conductive material to short circuit the windings of the rotor, and, on the other hand, reduces the eddy-current effect on the end part of the rotor and thus increases the efficiency of the motor.

The rotor could e.g. be formed as a squirrel cage rotor with axially disposed end parts forming short circuit rings for intermediately disposed conductors. The rotor could either be an internal rotor adapted to be arranged coaxially inside the stator with the first surface being the outer peripheral surface or an external rotor adapted to be arranged coaxially outside the stator with the first surface being the inner peripheral surface.

The first surface could have one portion being bevelled concavely or convexly towards the end of the rotor. It is typically desired to maintain the narrow gab between the rotor and the stator of an electrical motor clean and free from moist, oil and grease etc. Therefore, and in particular in applications wherein the rotor is mounted under wet or greasy conditions with its rotational axis vertically disposed, e.g. in an electromotor of a compressor, e.g. a compressor for cooling appliances, it may be an advantage to make the first surface with a stepped configuration. In that way it can be achieved that oil or similar wet or lubricious substances which, under influence of the centrifugal force could have been propelled from the short circuit ring towards the outer peripheral surface of the rotor and in between the gab between the rotor and the stator, can be thrown off from the short circuit ring. As an example, the first surface could, in addition to the curved surface portion have a straight surface portion, e.g. a tubular surface portion extending coaxially with the centre part of the rotor and being parallel with the centre axis. The ring may form further steps, e.g. two, three or even more than three steps. In order further to improve the rotors capability to throw off oil and similar substances, each of the steps may extend radially outwardly in a direction slightly axially towards the end parts of the rotor.

In one of, or in both of the rotor's axially disposed end parts, the rotor can be provided with a shoulder for support of a bearing.

In order to keep the manufacturing costs low, the rotor may be moulded into it's final shape in one piece, or, if more narrow tolerances are desired, the rotor may be moulded, e.g. by arranging a stack of individually isolated magnetically conductive plates in the mould of an injection moulding machine and, in a first process, moulding the body of the rotor. Subsequently, a part of the short circuit ring may be removed in a second cutting or grinding process. The rotor may e.g. be made from aluminium or compositions of metals e.g. comprising aluminium.

According to a second aspect, the present invention relates to an electrical motor of the kind provided with a stator generating a stray field and inducing an electrical field into conductors of a corresponding rotor, the rotor further comprising a short circuit ring extending axially towards an end part of the rotor characterized in that the short circuit ring is shaped and arranged with respect to the stator so that the intensity of the stray field on the short circuit ring is reduced towards the end part of the rotor.

The electrical motor may preferably be made with a distance between the rotor and the stator which is increased towards the end part of the rotor and, in general, with a rotor with any of the features according to the first aspect of the present invention.

Preferably, the motor is designed as an asynchronous motor or as a line-start motor with a permanent magnet and a squirrel cage rotor.

In a third aspect, the invention relates to the use of a rotor comprising:
a short circuit ring forming an end part of the rotor, said end part having the shape of an annular body with an outer peripheral surface and an inner peripheral surface coaxially extending around a centre axis, and wherein a first of either the outer peripheral surface or the inner peripheral surface adapted to be closest to the stator of an associated electrical motor slopes in a direction towards the other, second, surface,
   for an electrical motor for reducing the eddy-current braking effect caused by the windings of the stator, and in particular caused by the winding overhang, i.e. the part of the windings being closest to the short circuit rings. The third aspect of the invention could be combined with any of the features described in connection with the first aspect.

### BRIEF DESCRIPTION OF THE DRAWINGS

In the following, a preferred embodiment of the invention will be described in further details with reference to the drawing in which:

FIG. 1 shows a cross sectional view of a rotor according to the present invention arranged as an internal rotor in an electrical motor,

FIG. 2 shows a cross sectional view of a rotor according to the present invention arranged as an external rotor in an electrical motor,

FIG. 3 shows a cross sectional view of a rotor forming a part of a compressor unit for a refrigeration system,

FIG. 4 shows cross sectional views of different bevelled end parts of the short circuit ring of the rotor according to the present invention,

FIG. 5 shows a cross sectional view of an alternative cross sectional shape of a short circuit ring, and

FIG. 6 shows a diagram which shows the efficiency of a motor with a rotor according to the invention relative to the efficiency of a motor with a standard rotor of the kind known in the art.

### DETAILED DESCRIPTION OF THE INVENTION

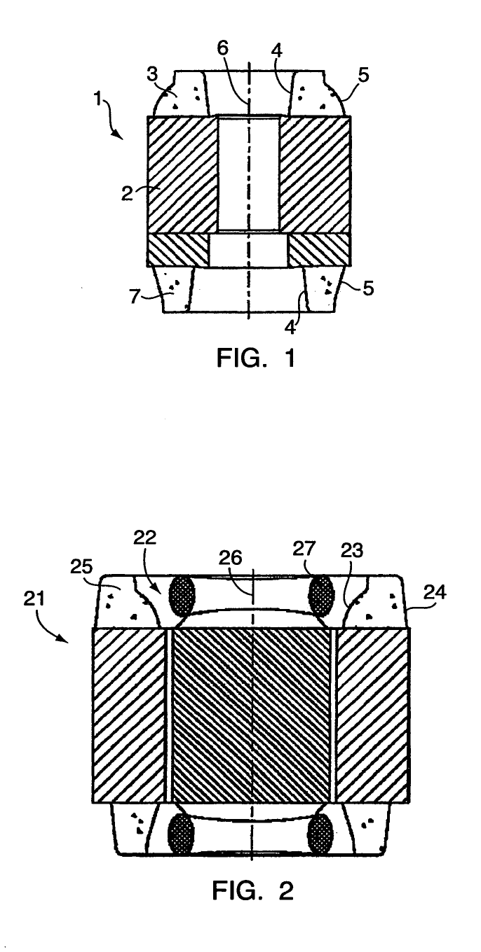

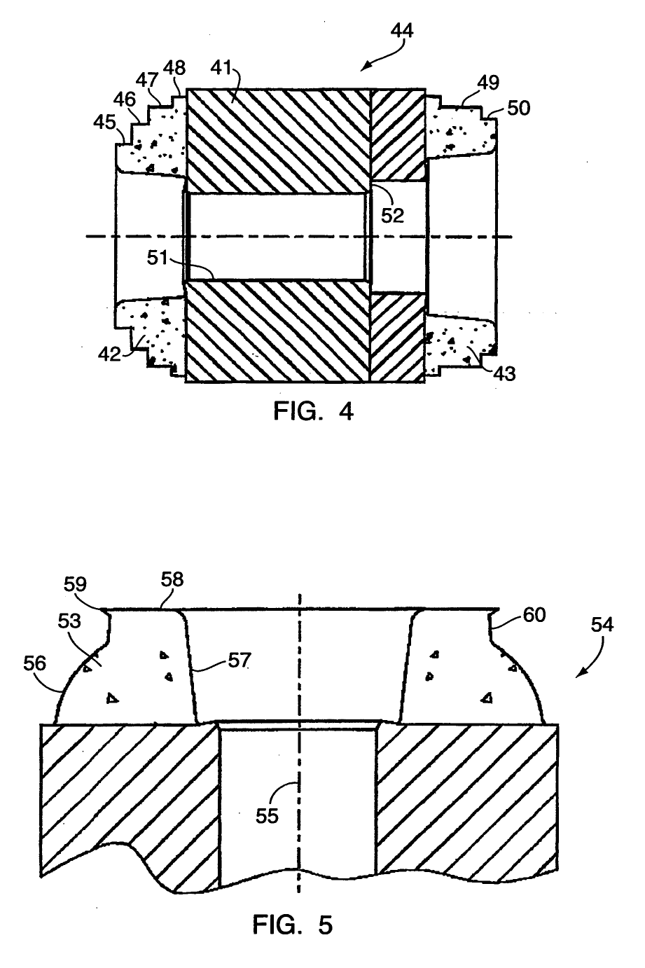

FIG. 1 shows a squirrel cage rotor 1 having a plurality of conductors fastened to or moulded into channels of a rotor core 2 and connected in each of the axially disposed ends to a short circuit ring 3, 7. The short circuit ring is annular with an inner peripheral surface 4 and an outer peripheral surface 5. The rotor can be arranged either internally inside or externally outside a tubular stator (not shown in FIG. 1) so that one of either the internal surface 4 or the external surface 5 becomes the one of the surfaces of the annular body being closest to the stator. In FIG. 1, the external surface 5 is adapted to be closest to a stator. The external surface is curved to increase the efficiency of the motor. The angle of a tangent to the curved surface has a numerical value which is larger than the corresponding angle of the internal surface 4 to the centre axis 6. In a cross sectional view, the internal and external surfaces are bevelled linearly towards each other. FIG. 4, however, shows three different cross sectional views of a short circuit ring, wherein the first surface is stepped or concave. The rotor core 2 of FIG. 1 is laminated from a plurality of sheets of a magnetically conductive material. Each of the layers is isolated from adjacent layers, e.g. by coating the sheets with a varnish or by inserting sheets of an isolating paper between the layers. As shown in FIG. 1, the short circuit ring 3 is different from the short circuit ring 7.

FIG. 2 shows an alternative embodiment of the rotor according to the invention. In FIG. 2, the rotor 21 is an external rotor arranged coaxially outside the stator 22. The first surface 23 of the two peripheral surfaces 23, 24 of the annular short circuit ring 25 faces towards, and is closest to the stator 22. The first surface is curved and defines an angle to the centre axis 26 which is larger than the angle of the second surface 24 to the centre axis 26. The stator comprises a stator winding 27 and the rotor core is laminated from sheets of a magnetically conductive material.

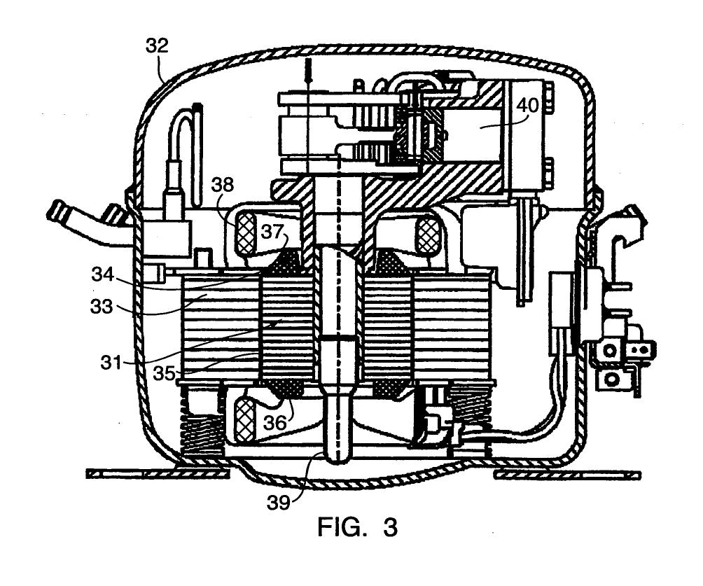

FIG. 3 shows a cross sectional view of a rotor 31 according to the present invention forming part of an electrical motor for a compressor. The compressor is of the kind adapted for use in refrigeration installations and comprises an outer housing 32 that is completely sealed from the surroundings.

The rotor is held in place inside the tubular stator part 33 by a single combined axial and radial bearing 34. For this purpose, the rotor is provided with a bearing seat—best seen in FIG. 4. Since the housing 32 is filled with a cooling liquid and optionally with lubricating oil, it is an aspect to design the rotor specifically with a view on avoiding contamination of the narrow gab 35 defined between the rotor and the stator. For this purpose, at least the short circuit ring 36, facing downwardly, can be made with a stepped configuration—shown in FIG. 4. The short circuit ring in FIG. 4 is, however, shown with a curved surface. Optionally, the other axially opposite short circuit ring 37 can be provided with a stepped configuration. The stepped configuration can be made during a moulding process wherein the conductors and the short circuit ring are formed in a single injection into the mould of an injection moulding machine. Due to its curved surface, the rotor is less influenced by the eddy-current braking effect generated by the stray field from the winding overhang 38 of the stator part. Further objects of interest can be mentioned, e.g. an oil pump 39 and a compressor with a compressor chamber 40.

FIG. 4 shows a rotor 44 for an electrical motor for a compressor, i.e. a rotor for a motor of the kind disclosed in FIG. 3. The rotor comprises a rotor core 41, e.g. laminated from a plurality of magnetically conductive layers. The core is provided with a plurality of channels extending substantially in the axial direction of the rotor. During the manufacturing of the rotor, the laminated stack is arranged in the mould of a machine for injection moulding and both of the axially disposed short circuit rings 42, 43 is moulded from a conductive material, e.g. aluminium, in a single injection of a moulding machine. During this moulding process, the conductive metal is pressed into the channels thereby affording the shape of a so called squirrel cage rotor. The short circuit rings are formed with a stepped outer peripheral surface, at one end forming the steps 45-48 and at the axially disposed opposite end forming the steps 49, 50. The substantially tubular rotor is formed with an internal surface 51 defining a seat 52 for a bearing for the fixation of the rotor in an electrical motor.

FIG. 5 shows a cross sectional view of an alternative cross sectional shape of a short circuit ring 53 of a rotor 54 rotating around the centre axis 55. The first surface 56 which is supposed to be the one of the two surfaces 56, 57 which is closest to an associated stator of an electrical motor is curved towards the end part 58 of the short circuit ring in a convex manner, i.e. an angle to the centre axis is increasing with the distance to a centre part of the rotor, i.e. the closer to the end part 58, the larger an angle of the tangent to the centre axis. The short circuit ring ends in a tip portion 59 bending slightly radially outwardly, i.e. away from the centre axis. Due to the tip portion, oil and similar substances can more efficiently be thrown off during rotation of the rotor, and contamination of the gab between the rotor and a stator can thus be prevented. The first surface 56 comprises further a straight portion 60 extending towards the end part 58 of the rotor. The straight portion is substantially parallel to the centre axis 55.

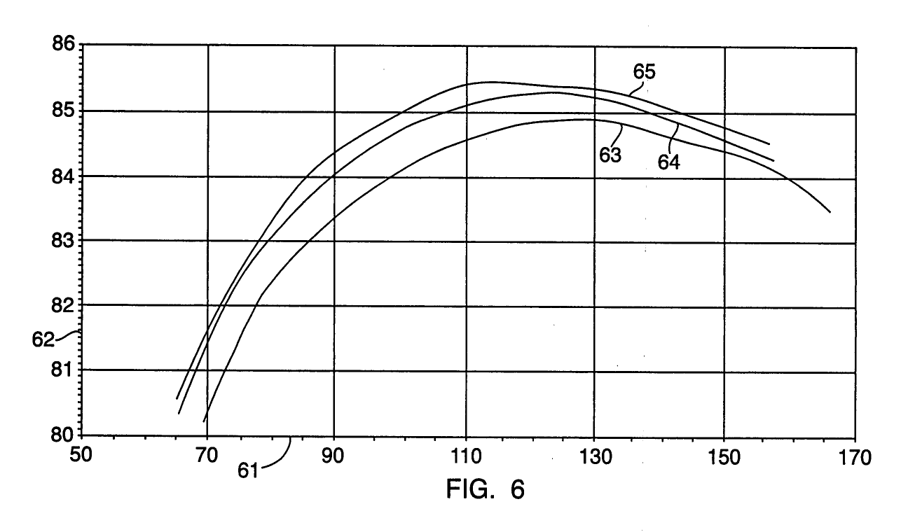

FIG. 6 shows in three graphs the relationship between, on the abscissa scale 61, the effect measured in Watt and, on the ordinal scale 62, the efficiency of a motor. Graph 63 relates to an ordinary motor of a kind known in the art, graph 64 relates to a motor with a rotor provided with a short circuit ring with a stepped configuration and graph 65 relates to a motor with a rotor provided with a short circuit ring with a curved surface portion in accordance with the present invention.

While the present invention has been illustrated and described with respect to a particular embodiment thereof, it should be appreciated by those of ordinary skill in the art that various modifications to this invention may be made without departing from the spirit and scope of the present invention.

1-16. (canceled)

17. A rotor for an electrical motor provided with a stator and a winding generating a stray field that induces a voltage into a short circuit ring of the rotor, the short circuit ring forming an end part of the rotor, said end part having the shape of an annular body with an outer peripheral surface and an inner peripheral surface coaxially extending around a centre axis, the first of either the outer peripheral surface or the inner peripheral surface adapted to be closest to the stator of the electrical motor comprises a curved portion which slopes in a direction towards the other, second, surface, and the first surface further comprises a straight portion extending towards the end part of the rotor, wherein said straight portion is substantially parallel to the centre axis.

18. The rotor according to claim 17, wherein a tangent to the curved portion forms an angle to the centre axis, the angle being numerically larger than an angle of the second surface to the centre axis.

19. The rotor according to claim 18, wherein the angle has a numerical value which is increasing with the distance to a centre part of the rotor.

20. The rotor according to claim 17, wherein the distance between the outer peripheral surface and the inner peripheral surface is reduced towards the end part of the rotor.

21. The rotor according to claim 17, wherein the rotor is formed as a squirrel cage rotor with two axially disposed end parts forming short circuit rings for intermediately disposed conductors.

22. The rotor according to claim 17, wherein the rotor is an internal rotor adapted to be arranged coaxially inside the stator with the first surface being the outer peripheral surface.

23. The rotor according to claim 17, wherein the first surface is provided with a stepped configuration.

24. The rotor according to claim 17, wherein the first surface is convex.

25. An electrical motor provided with a stator and a winding generating a stray field and inducing an electrical field into conductors of a corresponding rotor, the rotor further comprising a short circuit ring which forms an end part of the rotor wherein the short circuit ring is shaped and arranged with respect to the stator so that the intensity of the stray field on the short circuit ring is reduced towards the end part of the rotor.

26. The electrical motor according to claim 25, wherein a distance between the rotor and the stator is increased towards the end part of the rotor.

27. The electrical motor according to claim 25, wherein said end part of the rotor has the shape of an annular body with an outer peripheral surface and an inner peripheral surface coaxially extending around a centre axis, the first of either the outer peripheral surface or the inner peripheral surface adapted to be closest to the stator of the electrical motor comprises a curved portion which slopes in a direction towards the other, second, surface, and the first surface further comprises a straight portion extending towards the end part of the rotor, wherein said straight portion is substantially parallel to the centre axis.

28. The electrical motor according to claim 25, designed as an asynchronous motor.

29. The electrical motor according to claim 25, designed as a line-start motor with a permanent magnet and a squirrel cage rotor.

30. A rotor comprising:
a short circuit ring forming an end part of the rotor, said end part having the shape of an annular body with an outer peripheral surface and an inner peripheral surface coaxially extending around a centre axis, and wherein a first of either the outer peripheral surface or the inner peripheral surface adapted to be closest to the stator of an associated electrical motor slopes in a direction towards the other, second, surface, for reducing the eddy-current braking effect introduced by a stray field from the winding overhang of a corresponding stator.
